(19) United States
(12) Patent Application Publication
(10) Pub. No.: US 2021/0118316 A1
(43) Pub. Date: Apr. 22, 2021

(54) DOCUMENT CHECKING SYSTEM AND GRADING SYSTEM

(71) Applicant: FUJI XEROX CO., LTD., Tokyo (JP)

(72) Inventors: Naoyuki ENOMOTO, Kanagawa (JP); Tadao MICHIMURA, Kanagawa (JP); Shinya NAKAMURA, Kanagawa (JP); Norio YAMAMOTO, Kanagawa (JP); Jun ANDO, Kanagawa (JP)

(73) Assignee: FUJI XEROX CO., LTD., Tokyo (JP)

(21) Appl. No.: 16/865,773

(22) Filed: May 4, 2020

(30) Foreign Application Priority Data
Oct. 21, 2019 (JP) 2019-192311

(51) Int. Cl. G09B 7/02; G06F 16/903

(52) U.S. Cl. CPC G09B 7/02; G06F 16/90348

(57) ABSTRACT

A document checking system includes a processor configured to analyze a result of checking a document, and a memory configured to store a database that holds the analyzed check result. The processor is configured to: acquire checked documents that are generated by plural checkers individually checking the document; extract (i) notes added by the checkers to the checked documents and (ii) marks specifying descriptions related to the notes in the checked documents; when check information including information on the note and the mark on each extracted checked document satisfies a predetermined condition, determine a check result and register the determined check result in the database; and when the check information does not satisfy the condition, notify an administrator of the check result, determine the check result based on a determination result made by the administrator and register the determined check result in the database.

### CROSS-REFERENCE TO RELATED APPLICATIONS

This application is based on and claims priority under 35 USC 119 from Japanese Patent Application No. 2019-192311 filed Oct. 21, 2019.

### BACKGROUND

### 1. Technical Field

The present disclosure relates to a document checking system and a grading system.

### 2. Related Art

When plural checkers check content of a document, it is required to reduce bias and variation in the checked content and judgment among the checkers. As a specific example of the case where the plural checkers check the document, plural graders grade a test. In this example, measures are taken to reduce the bias and variation in grading results and grading criteria among the graders.

JP-A-2006-277086 discloses the followings. That is, a grading support device 1 outputs a result of grading by a grader and a result of grading by another grader to the grader. If the results of grading by the plural graders do not match, a grading management device 2 outputs results of grading including scores and reasons for grading to a grading manager who manages the results of grading by the graders, and receives a final grading result. The grading management device 2 also collects and outputs the results of analysis for each grader. The grading management device 2 collects and outputs the results of grading for answer sheets. Further, in a system described in JP-A-2006-277086, grading is performed based on grading criteria prepared in advance, and the grading criteria are corrected and updated as necessary.

JP-A-2018-142248 discloses an answer sheet grading system that transmits selected answer sheet information from a host computer to client computers, receives replies with grading information input by graders in response to the answer sheet information, and accumulates the grading information. Further, in the system described in JP-A-2018-142248, grading is performed based on grading criteria prepared in advance.

JP-A-2018-142249 discloses an answer sheet grading method including transmitting selected answer sheet information from a host computer to client computers, receiving replies with grading information input by graders in response to the answer sheet information, collecting results of scores for the answer sheets, and employing a result of a score having a high reliability. Further, in the method described in JP-A-2018-142249, grading is performed based on grading criteria prepared in advance.

### SUMMARY

When a document is checked by plural checkers, it may be difficult to prepare judgement criteria for checking content of the document in some cases. In addition, how to evaluate the content that is out of the criteria may be an issue. For example, it takes a great deal of time to prepare grading criteria in advance for each of tests that are frequently performed in a short time. In grading a descriptive test, importance may be attached to how to evaluate a description that deviates from the grading criteria, how to evaluate an unexpected description, and the like may in some cases.

Aspects of non-limiting embodiments of the present disclosure relate to implementing a system that reduces bias and variation in checking content and judgment without preparing judgment criteria for checking when a document is checked by plural checkers. In particular, an aspect of non-limiting embodiments of the present disclosure relate to implementing a grading system that reduces a variation in grading by plural graders without preparing grading criteria in advance in grading a test.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided a document checking system including a processor configured to analyze a result of checking a document, and a memory configured to store a database that holds the analyzed check result. The processor is configured to: acquire checked documents that are generated by plural checkers individually checking the document; extract (i) notes added by the checkers to the checked documents and (ii) marks specifying descriptions related to the notes in the checked documents; when check information including information on the note and the mark on each extracted checked document satisfies a predetermined condition, determine a check result and register the determined check result in the database; and when the check information does not satisfy the condition, notify an administrator of the check result, determine the check result based on a determination result made by the administrator and register the determined check result in the database.

### BRIEF DESCRIPTION OF THE DRAWINGS

Exemplary embodiment(s) of the present disclosure will be described in detail based on the following figures, wherein:

FIG. 1 is a diagram showing an overall configuration of an information processing system according to an exemplary embodiment;

FIG. 2 is a diagram showing a configuration example of an answer sheet;

FIG. 3 is a diagram showing a configuration example of hardware of a grading system;

FIG. 4 is a diagram showing conditions under which a graded answer sheet is set as a notification target to a grading manager;

FIG. 5 is a flowchart showing operations of the grading system;

FIG. 6 is a diagram showing an example of the graded answer sheets;

FIG. 7 is a diagram showing another example of the graded answer sheets;

FIG. 8 is a diagram showing still another example of the graded answer sheets; and

FIG. 9 is a diagram showing further another example of the graded answer sheets.

### DETAILED DESCRIPTION

Hereinafter, an exemplary embodiment of the present disclosure will be described in detail with reference to the accompanying drawings. Here, it is assumed that a scene in which a test is graded by plural graders is used as a specific scene in which plural checkers check content of a document. Hereinafter, a case in which a document checking system according to the present exemplary embodiment is applied to a grading system that evaluates answer sheets graded by the plural graders will be described as an example.

### <System Configuration>

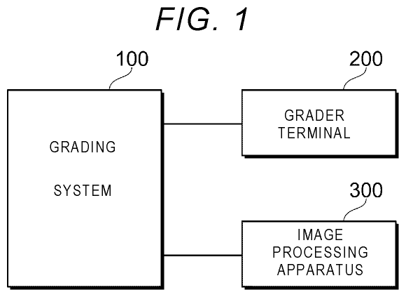

FIG. 1 is a diagram showing an overall configuration of an information processing system according to the present exemplary embodiment. The information processing system according to the present exemplary embodiment includes a grading system 100, a grader terminal 200, and an image processing apparatus 300. FIG. 1 shows one grader terminal 200 and one image processing apparatus 300. It is noted that, for example, the graders may have the grader terminals 200, respectively and the grader terminals 200 may be connected to the grading system 100. Plural image processing apparatuses 300 may be connected to the grading system 100. Although not particularly shown, the grading system 100 may be connected to and cooperate with a training management system and an e-mail system. The grading system 100 is an example of the document checking system.

The grading system 100 is a server that acquires data of the graded answer sheets, adjusts and determines a grading result, and then stores the determined grading result in a database for management. The grading system 100 is implemented, for example, as a server on a network. The grading system 100 is not limited to a configuration using a single piece of hardware (such as a server machine), but may be distributed to plural pieces of hardware or virtual machines. The grading system 100 may be implemented as a local system, or may be implemented by a cloud service or the like.

The grader terminal 200 is an information processing device that allows the grader to input a grading result and sends the grading result to the grading system 100. The grader terminal 200 is implemented by, for example, a personal computer, a smartphone, or the like. The grader terminal 200 includes a display that displays an answer sheet, and a receiver. A user can grade the answer sheet on a screen displayed on the display. As the receiver, for example, an input device such as a keyboard, a mouse, and a touch panel, and a controller for the input device are provided. The user refers to the answer sheet screen displayed on the display and performs an operation of specifying a display range by the input device, an operation of inputting an evaluation for the specified display range, and an operation of inputting a score of the answer sheet. The grader terminal 200 receives the input by these operations with the receiver. The grader terminal 200 transmits data of the grading result to the grading system 100. The grader terminal 200 is an example of an input unit.

The image processing apparatus 300 is a device that reads the answer sheet and creates electronic data of an image of the answer sheet. The image processing apparatus 300 includes a so-called scanner. The image processing apparatus 300 optically reads an image on a placed document, and generates a read image (image data). As an image reading method, for example, a charge coupled device (CCD) method or a contact image sensor (CIS) method may be used. In the CCD method, reflected light of light emitted from a light source to the document is reduced by a lens and received by the CCDs. In the CIS method, reflected light of light sequentially emitted from a light emitting diode (LED) light source to the document is received by the CIS. The image processing apparatus 300 is connected to the grading system 100 via the network. The image processing apparatus 300 has a communication function of transmitting the image data of the read answer sheet. The image processing apparatus 300 may be a device configured as a single scanner, or may be a so-called multifunction device including an image forming device and the like. The image processing apparatus 300 is an example of the input unit.

### Configuration Example of Answer Sheet

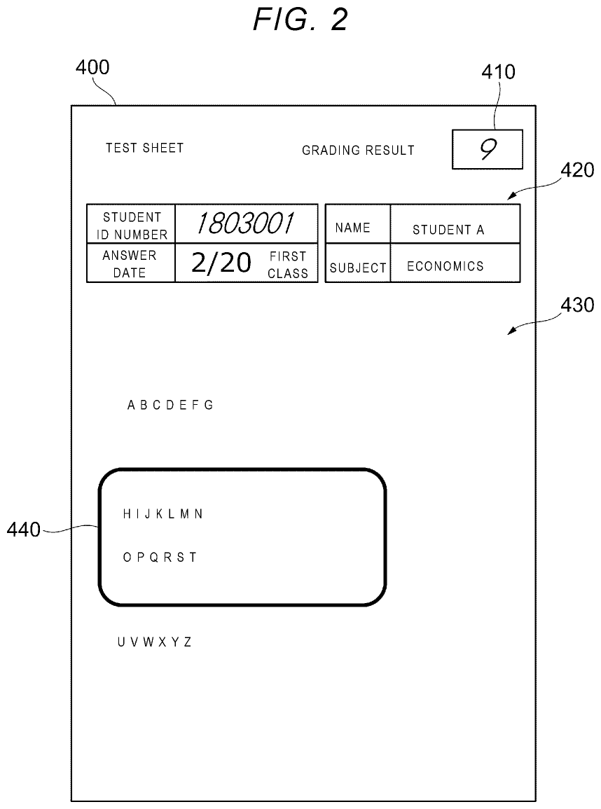

FIG. 2 is a diagram showing a configuration example of an answer sheet. An answer sheet 400 to be processed has, for example, a predetermined format and configuration. The answer sheet 400 shown in FIG. 2 includes a score field 410, a bibliographic information field 420, and an answer field 430. In addition, on the answer sheet 400 shown in FIG. 2, an attention point mark 440 is attached by an operation of the grader. The answer sheet 400 on which an answerer writes an answer when having a test is an answered answer sheet. The answered answer sheet is a specific example of a document to be checked by plural checkers. The graded answer sheet is an answered answer sheet that is graded by the grader. On the graded answer sheet, a score entered in the score field 410 is a note added to a document (that is, the answered answer sheet) by the grader who is the checker, and the attention point mark 440 is a mark specifying a description related to the note in the document.

The score field 410 records the score as the grading result by the grader. In the bibliographic information field 420, various information related to the answer sheet are recorded. In the example shown in FIG. 2, (i) a student ID number and a name that are identification information of an answerer, (ii) an answer date and time, and (iii) a subject indicating a type of questions are recorded. In the answer field 430, an answer of the answerer is recorded. Here, it is assumed that the answerer enters a text as an answer to a descriptive question.

The attention point mark 440 is a mark indicating a part of a description (attention point), based on which the grader grades the score, among the answers described in the answer field 430. The attention point mark 440 is configured so as to specify the part of the description to which the grader pays attention in grading and to specify content of evaluation (that is, to indicate that some points are added or deducted). In the example shown in FIG. 2, the description in the part to which the grader pays attention is specified by surrounding the description with a frame. The content of the evaluation is indicated by, for example, a type of the frame. Specifically, different types of lines may be used, different display colors may be used, or frames in different shapes may be used.

After the answerer answers the test, the answer sheet 400 is collected, distributed to plural graders, and graded. At this time, each answered answer sheet is distributed to the plural graders. However, not all the answered answer sheets are graded by all graders. The grader may grade the answer sheet by handwriting, or may grade the answer sheet displayed on the screen of the grader terminal 200. The grading of the answer sheet includes adding the attention point mark 440 to the answer sheet. After the grader grades the answer sheet distributed to him or her, the grader transmits the graded answer sheet to the grading system 100 using the grader terminal 200 or the image processing apparatus 300.

Each grader points out an attention point on the answer sheet and shows evaluation for that point. Thus, for the results of grading by the plural graders, the attention points provided by the individual graders and the evaluations thereof can be compared to determine whether the attention points and the evaluations are similar or different. Then, when the attention points provided by the individual graders and the evaluations thereof are different from each other, the grading manager makes an adjustment, so that even when grading criteria are not prepared in advance, it is possible to reduce a variation in the results of grading by the individual graders.

When the answered answer sheets are distributed to the graders, an amount of the answered answer sheets to be distributed to each grader may be changed according to an amount of descriptions on the answered answer sheets, so that work time of the graders is equalized as much as possible. A distribution destination may be adjusted such that only answered answer sheets having a large amount of descriptions are not distributed to a specific grader. The distribution destinations may be adjusted such that an answered answer sheet having a large amount of description is distributed to a skilled grader who is more accustomed to grading work. The distribution destinations may be adjusted based on not only the amount of description on the answered answer sheet but also the content of the description. For example, optical character recognition (OCR) may be performed on the answer fields 430 on the answered answer sheets. The recognition results may be analyzed and answered answer sheets having a high similarity to each other may be distributed to the same grader. As to the similarity, for example, keywords are extracted from the results of the optical character recognition, and the similarity is determined according to the number of common keywords. That is, it is determined that the answered answer sheets containing many common keywords have a high similarity.

### <Configuration of Grading System 100>

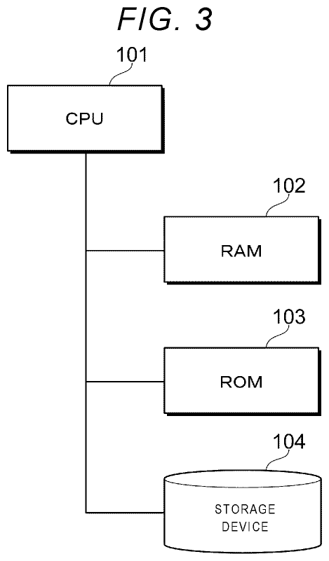

FIG. 3 is a diagram showing a configuration example of hardware of the grading system 100. The grading system 100 is implemented by a computer. The grading system 100 includes a central processing unit (CPU) 101 as an arithmetic unit, a random access memory (RAM) 102, a read only memory (ROM) 103, and a storage device 104 which serve as storage units. The RAM 102 is a main storage device (main memory). The RAM 102 is used as a working memory when the CPU 101 executes arithmetic processing. The ROM 103 stores programs and data such as setting values prepared in advance. The CPU 101 can read the programs and the data directly from the ROM 103 to execute processing. The storage device 104 is a storage unit that stores programs and data. The storage device 104 stores the programs. The CPU 101 reads a program stored in the storage device 104 into the main storage device and executes the program. The storage device 104 stores and saves a result of the processing executed by the CPU 101. As the storage device 104, for example, a magnetic disk device or a solid state drive (SSD) is used.

The grading system 100 implements, for example, functions of analyzing a graded answer sheet, and adjusting, determining, and managing grading results by the CPU 101 executing the program. Specifically, the CPU 101 implements various functions such as a function of acquiring graded answer sheets, a function of storing a grading result, a notification function, and a function of evaluating a grading result. The graded answer sheet for which the grading result is determined is stored and managed in, for example, a database constructed in the storage device 104. The graded answer sheet for which the grading result is determined may be stored in an external storage server provided separately from the grading system 100.

The CPU 101 acquires the graded answer sheets by the function of acquiring graded answer sheets implemented by executing the program. The graded answer sheet is obtained from the grader terminal 200 or the image processing apparatus 300 which is used as the input unit. The CPU 101 acquires electronic data of graded answer sheets from the grader terminal 200. The CPU 101 acquires, from the image processing apparatus 300, image data of the graded answer sheets that are read by an image reading process.

The CPU 101 detects the attention point mark 440 added to each graded answer sheet by a function of detecting an attention point mark implemented by executing the program. With regard to the detected attention point mark 440, the CPU 101 specifies a position where the attention point mark 440 is added in the answer field 430, a region indicated by the attention point mark 440, and a type of the attention point mark 440 (that is, the attention point mark 440 is either a mark indicating that some points are added or a mark indicating that some points are deduced).

The CPU 101 evaluates a score of each graded answer sheet and the detected attention point mark 440 by the function of evaluating a grading result implemented by executing the program. Firstly, the CPU 101 recognizes the score recorded in the score field 410 on the graded answer sheet. When the score is recorded in characters, the CPU 101 recognizes the score, for example, by the optical character recognition. When the score field 410 is configured such that the grader marks different positions according to the score, the CPU 101 can recognize the score according to the marked position without performing the optical character recognition.

The CPU 101 extracts information on the attention point mark 440 on the graded answer sheet. Specifically, the CPU 101 specifies content of the evaluation indicated by the number, the position, and the region (range of a description indicated by the attention point mark 440) of the attention point mark 440 added to the answer field 430, the type of the attention point mark 440, and the like. The CPU 101 may perform the optical character recognition on the description indicated by the attention point mark 440.

When the CPU 101 determines that, for the attention point marks 440 on plural graded answer sheets, the same type of the evaluation is given to the same description in the answer fields 430, the CPU 101 determines a difference between the scores recognized from the graded answer sheets. Then, when the difference between the scores is smaller than a predetermined threshold value, the CPU 101 unifies the cores into a unified score and determines the unified score. The CPU 101 unifies the scores, for example, by taking an average value of the scores of the graded answer sheets. When there are three or more graded answer sheets, the CPU 101 obtains plural differences among the scores of the graded answer sheets. In this case, the CPU 101 determines a difference between the highest score and the lowest score.

On the other hand, when the difference between the scores of the plural graded answer sheets is larger than the threshold value, the CPU 101 notifies the grading manager of the results of evaluating the plural graded answer sheets by the notification function implemented by executing the program. Upon receipt of this notification, the grading manager re-grades the graded answer sheets and sends a result to the grading system 100. When receiving the grading result from the grading manager, the CPU 101 of the grading system 100 determines the grading result based on content thereof.

When the CPU 101 determines that, for the attention point marks 440 of the plural graded answer sheets, the same type of the evaluation is not given to the same descriptions in the answer fields 430, the CPU 101 notifies the grading manager of the results of evaluating the plural graded answer sheets. Upon receipt of this notification, the grading manager re-grades the graded answer sheets and sends a result to the grading system 100. When receiving the grading result from the grading manager, the CPU 101 of the grading system 100 determines the grading result based on content thereof. It is noted that details of a case where the CPU 101 determines that the attention point marks 440 do not indicate that the same type of the evaluation is given to the same descriptions in the answer fields 430 will be described later.

The CPU 101 stores and manages information on the answer sheet for which the grading result is determined in a database by a function of managing a grading result implemented by executing the program. The answer sheets for which grading results are determined are classified into (i) answer sheets (a) for which a determination is made that the same type of the evaluation is given to the same descriptions in the answer fields 430 and (b) a score difference between which is smaller than the threshold value and (ii) answer sheets graded by the grading manager. In the former case (that is, the case (i)), the answer sheets are managed based on the unified score. In the latter case (that is, the case (ii)), the answer sheets are managed based on a score graded by the grading manager.

### <Evaluation of Attention Point Mark 440>

Here, evaluation of the attention point mark 440 will be further described. The attention point mark 440 indicates various information on the description indicated by the attention point mark 440 in the answer field 430 with external features such as the number, the position, the size of an indicated region, and the type of the mark. Therefore, the CPU 101 firstly evaluates the attention point mark 440 based on these external features. The evaluation based on the external features of the attention point mark 440 may be given, for example, in the following procedure.

First, the CPU 101 compares the numbers of the attention point marks 440 added to the graded answer sheets. When the numbers of the attention point marks 440 are the same, the CPU 101 compares the positions of the attention point marks 440. Then, when the attention point marks 440 are added to different positions, the CPU 101 sets each graded answer sheet as a notification target to the grading manager. Here, since it is considered that it is rare that the positions of the attention point marks 440 added to descriptive answers are completely the same, a condition for determining the same position may be relaxed. For example, if the attention point marks 440 are added at positions where some of the attention point marks 440 overlap with each other, the CPU 101 may determine that the attention point marks 440 are added at the same position. When the attention point marks 440 are added at the same position in a part of plural graded answer sheets, a group with the largest number of answer sheets in which the attention point marks 440 are added to the same position may be used as a reference, and the other graded answer sheets may be treated as answer sheets in which the attention point marks 440 are added at different positions.

When there are plural graded answer sheets for which it is determined that the attention point marks 440 are added at the same position, the CPU 101 compares the sizes of the regions indicated by the attention point marks 440 in these graded answer sheets. When comparing the numbers of the attention point marks 440 added to the graded answer sheets, if the numbers are not the same, the CPU 101 compares sums of the sizes of the regions indicated by the attention point marks 440 in the graded answer sheets. The size of the region indicated by the attention point mark 440 may be, for example, an area of the region surrounded by the frame when the attention point mark 440 is added as a frame surrounding an attention part. The size of the region may be represented by the number of lines or characters of text described in the region indicated by the attention point mark 440.

When a difference between the sizes of the regions indicated by the attention point mark 440 which are added to the graded answer sheets is larger than a predetermined threshold value, the CPU 101 sets each graded answer sheet as the notification target to the grading manager. On the other hand, when the differences between the sizes of the regions indicated by attention point marks 440 is smaller than the threshold value, the CPU 101 compares the contents of the evaluations indicated by the types of the attention point marks 440. When one graded answer sheet and another graded answer sheet are different in the type of the attention point mark 440, even if the numbers, the positions, and the regions of the attention point marks 440 are the same, the content of the evaluations (that is, the evaluations indicate that some points are added or deduced) differs depending on the grader. Therefore, in this case, the CPU 101 sets these graded answer sheets as the notification targets to the grading manager. In contrast, when the types of the attention point mark 440 are the same in the plural graded answer sheets, the CPU 101 determines that the attention points of the graders in the graded answer sheets and the evaluations thereof are the same.

When determining that the attention points of the graders and the evaluations thereof are the same in the plural graded answer sheets, the CPU 101 compares the scores of all the graded answer sheets by the function of managing a grading result. Then, when the difference between the scores is smaller than the threshold value, the CPU 101 unifies and determines the scores of all the graded answer sheets, and stores information on the answer sheets in the database. On the other hand, when the difference between the scores is larger than the threshold value, the CPU 101 sets each graded answer sheet as the notification target to the grading manager.

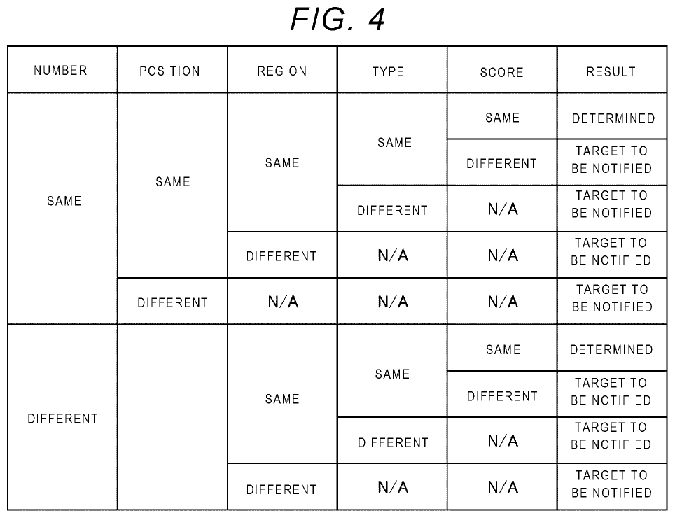

FIG. 4 is a diagram showing conditions under which a graded answer sheet is set as a notification target to the grading manager. In the above example, firstly, for the graded answer sheets having the same number of attention point marks 440, positions of the attention point marks 440 are compared, and if the positions are different, the graded answer sheets are set as notification targets. When the positions of the attention point marks 440 are the same, the sizes of the regions thereof are compared, and if the sizes are different, the graded answer sheets are set as notification targets. Further, when the numbers of the attention point marks 440 are different, the sums of the sizes of the regions indicated by all the attention point marks 440 are compared, and if the sums are different, the graded answer sheets are set as notification targets. Then, even if the sizes of the regions indicated by the attention point marks 440 are the same, when types of the attention point mark 440 are different, the graded answer sheets are set as notification targets. Further, even if the types of the attention point marks 440 are the same, when the graded answer sheets have different scores, the graded answer sheets are set as notification targets.

It is noted that the above example is merely an example of a procedure for executing the evaluation based on the external features of the attention point mark 440. The evaluation may be given in another procedure. When it is determined that the attention points of the graders and the evaluations thereof are the same in the plural graded answer sheets according to the evaluation based on the external features of the attention point mark 440, the CPU 101 may further perform optical character recognition on the descriptions indicated by the attention point marks 440 and compare contents of the descriptions. The contents of the descriptions are compared, for example, by expressing the results of recognizing characters in description in a document vector and determining a similarity between the vectors. Alternatively, keywords may be simply extracted from a result of the optical character recognition, and the similarity may be determined based on the number of common keywords. When the evaluation is given based on the similarity of the document vectors, for example, when the obtained similarity is larger than a predetermined threshold value, the CPU 101 determines that the contents of the descriptions of the region indicated by the attention point mark 440 are the same. On the other hand, when the similarity is smaller than the threshold value, the CPU 101 determines that the contents of the descriptions of the region indicated by the attention point mark 440 are different, and sets the graded answer sheet as the notification target to the grading manager.

When the graded answer sheet is set as the notification target to the grading manager according to the evaluation of the attention point mark 440, the evaluation may be given using the optical character recognition before a notification is made to the grading manager. In this case, for example, characters in the descriptions of the regions indicated by the attention point marks 440 in the graded answer sheets which are set as the notification targets are recognized and expressed in the document vector as described above. Then, the similarity therebetween is determined to evaluate the contents of the descriptions. As described above, when the character recognition is performed to determine the similarity, the specific contents of the descriptions can be evaluated, so that accuracy of the evaluation of the descriptions indicated by the attention point marks 440 is improved. However, since the optical character recognition process has a high execution load and a load on the grading system 100 is high, the optical character recognition may be performed in a limited manner, such as being performed after the evaluation based on the external features of the attention point mark 440 as described above.

### <Operation of Grading System 100>

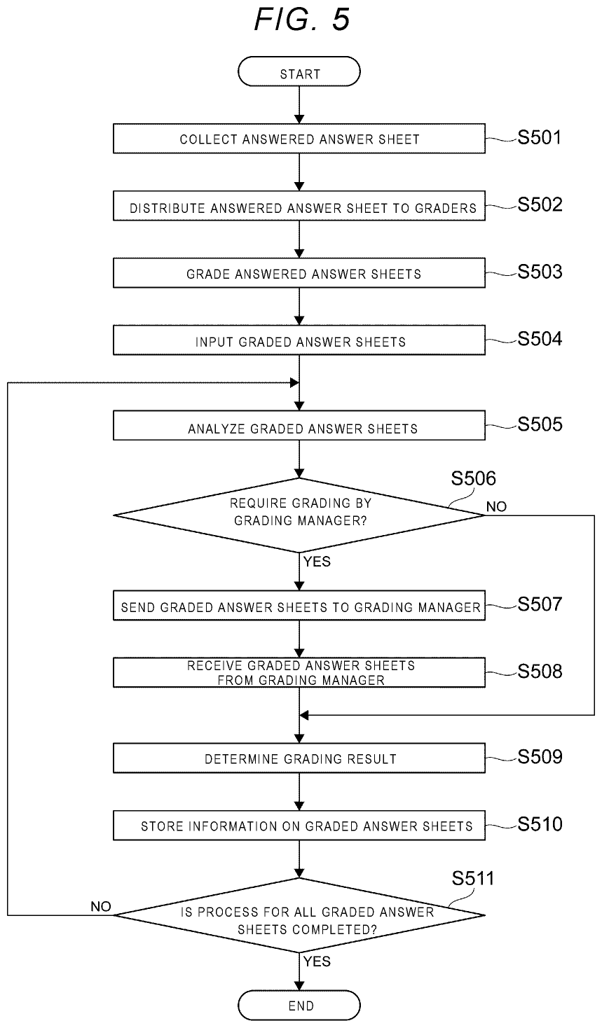

FIG. 5 is a flowchart showing operations of the grading system 100. In an operation example shown in FIG. 5, an operation at a stage before electronic data of a graded answer sheet is input to the grading system 100 is also shown. Firstly, when an answerer has a test and an answered answer sheet is collected (S501), the answered answer sheet is distributed to the graders (S502). The answered answer sheet may be distributed in the form of electronic data obtained by reading the answered answer sheet using the image processing apparatus 300 or the like. Alternatively, the answered answer sheet may be distributed in the form of paper.

When the answered answer sheet is graded by each grader (S503), the graded answer sheets are input to the grading system 100 (S504). As described above, the graded answer sheets may be input directly in the form of electronic data from the grader terminal 200, or may be input in the form of electronic image data obtained by reading the graded answer sheets using the image processing apparatus 300.

Upon receipt of the graded answer sheets, the grading system 100 analyzes the graded answer sheets using the various functions described above (S505). Then, for graded answer sheets which do not require grading by the grading manager (NO in S506), a grading result is determined (S509), and information on the graded answer sheet is stored in the database (S510).

On the other hand, graded answer sheet which require grading by the grading manager (YES in S506) are sent to the grading manager (S507) and re-graded by the grading manager. Then, the graded answer sheets re-graded by the grading manager are input to the grading system 100 again. When the grading system 100 receives the graded answer sheets re-graded by the grading manager (S508), the grading result is determined based on content thereof (S509), and information on the graded answer sheet is stored in the database (S510). Then, the grading system 100 completes the process after grading results are determined for all the graded answer sheets and saved in the database (S511).

### Example of Graded Answer Sheet

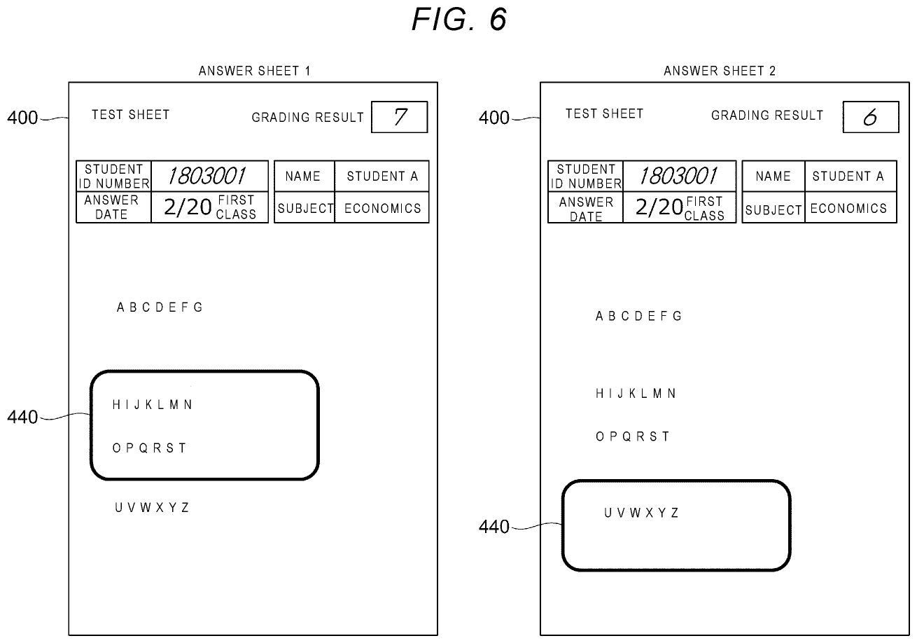

FIGS. 6 to 9 are diagrams showing examples of the graded answer sheet. In the example shown in FIG. 6, positions of the attention point marks 440 on two graded answer sheets (answer sheet 1 and answer sheet 2) are different. Therefore, these graded answer sheets are the notification target to the grading manager.

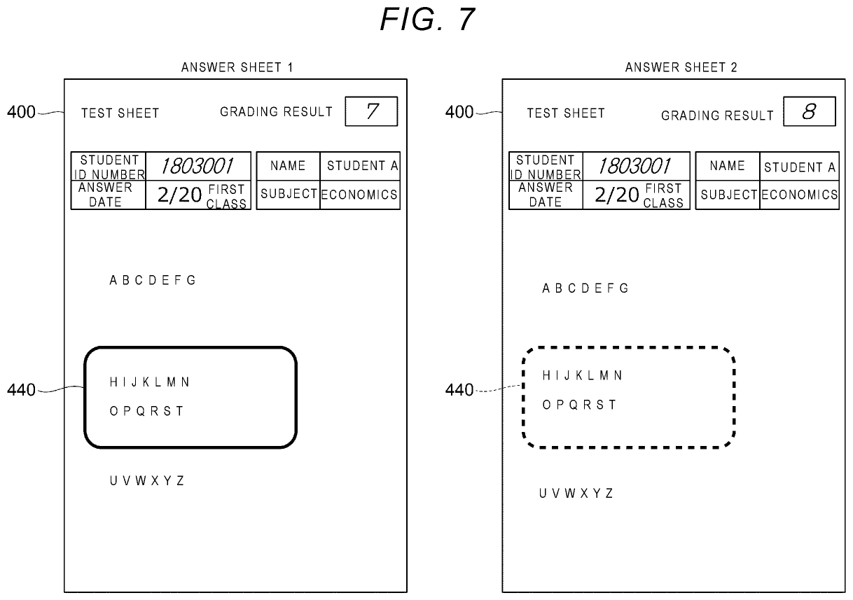

In the example shown in FIG. 7, the positions and the regions of the attention point marks 440 on the two graded answer sheets are the same, but the types of the frames of the attention point marks 440 are different, that is, content of the evaluation as to whether some points are added or deduced is different. Here, when some points are added, a solid line is used as the frame of the attention point mark 440, and when some points are deduced, a broke line is used as the frame of the attention point mark 440. In the example shown in FIG. 7, the frame of the attention point mark 440 on the answer sheet 1 is the solid line indicating that some points are added, while the frame of the attention point mark 440 on the answer sheet 2 is the broken line indicating that some points are deduced. Therefore, these graded answer sheets are the notification target to the grading manager.

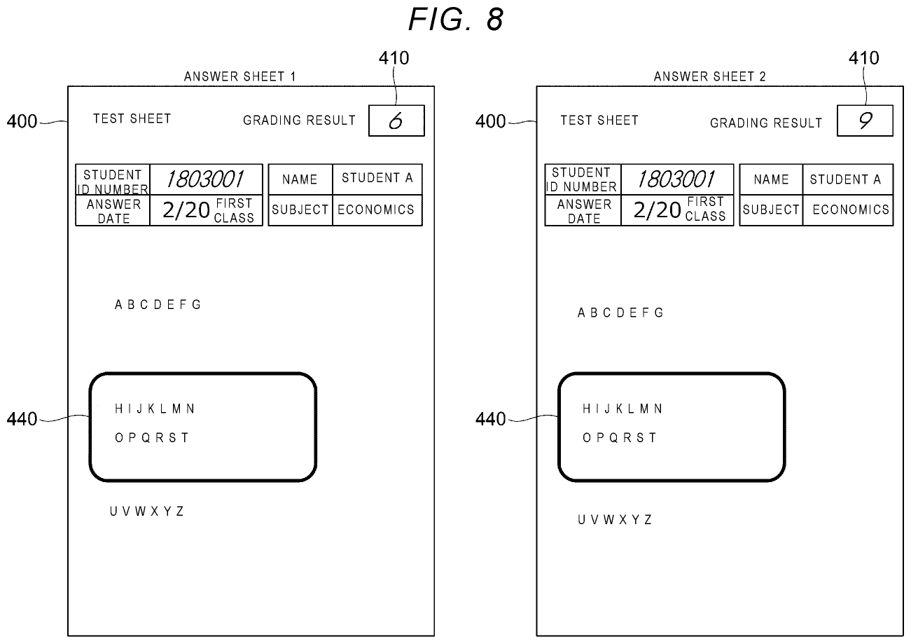

In the example shown in FIG. 8, the positions and the regions of the attention point marks 440 on the two graded answer sheets are the same, and the types of the attention point marks 440 are the same, but the scores of the two graded answer sheets are largely different. Here, it is assumed that the threshold value is 2. In this example, the score of the answer sheet 1 is 6 points, and the score of the answer sheet 2 is 9 points. A difference therebetween is larger than the threshold value. Therefore, these graded answer sheets are the notification targets to the grading manager.

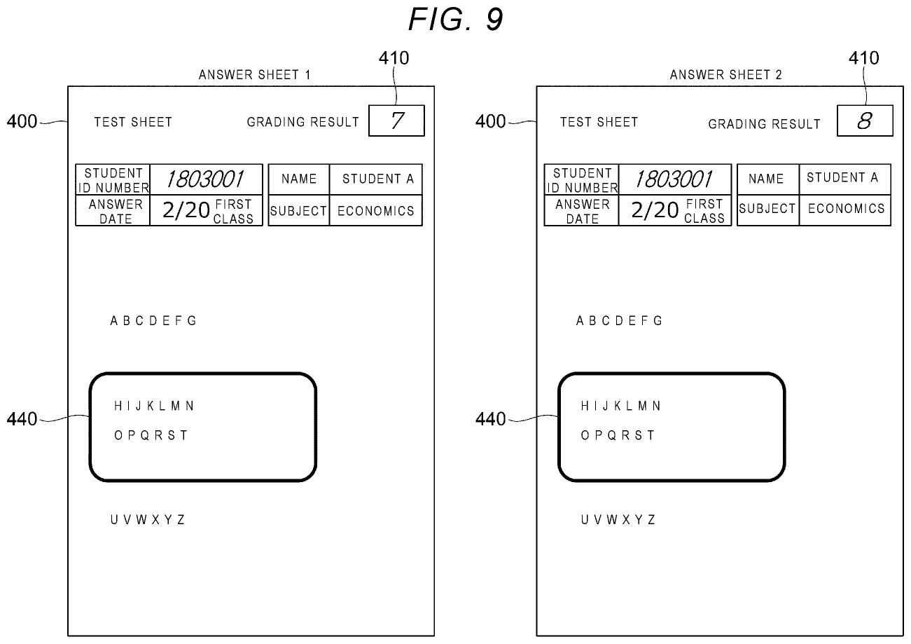

In the example shown in FIG. 9, the positions and the regions of the attention point marks 440 on the two graded answer sheets are the same, and the types of the attention point marks 440 are the same. Here, the score of the answer sheet 1 is 7 points, and the score of the answer sheet 2 is 8 points. A difference therebetween is smaller than the threshold value. Therefore, the scores of these graded answer sheets are unified and determined, and then stored and managed in the database. Here, it is assumed that an average is taken as a method of unifying scores and that there are two graded answer sheets shown in FIG. 9. An average score is 7.5 including a decimal. In such a case, a fraction process such as rounding up a value after a decimal point may be performed and managed as an integer score (in this case, 8 points).

The exemplary embodiment of the present disclosure is described above. The technical scope of the present disclosure is not limited to the above exemplary embodiment. For example, in the above-described exemplary embodiment, when different evaluations are given to the attention point indicated by the attention point mark 440, the attention point marks 440 of different types are used. Alternatively, the type of the attention point mark 440 may not be changed in accordance with the evaluation, but a numeral or a character representing the content of the evaluation may be added to the attention point mark 440. Further, in the above-described exemplary embodiment, the graded answer sheet for which the grading result is determined is stored in the storage device 104. Alternatively, such a graded answer sheet may be stored in a storage server provided separately from the grading system 100.

The present exemplary embodiment may be applied to various systems for evaluating results of checking a document by plural checkers, other than grading a test. The document checking system acquires checked documents that are generated by plural checkers individually checking a document. Then, the document checking system extracts and evaluates notes added by the checkers to the checked documents and marks specifying descriptions related to the notes, on the document. When check information including information on the note and the mark specifying the note in each extracted checked document satisfies a predetermined condition, the document checking system determines a check result and registers the determined check result in the database. On the other hand, when the check information does not satisfy the condition, the document checking system notifies an administrator of the check result, determines the check result based on a determination result made by the administrator, and registers the determined check result in the database. Various changes and substitutions of configurations that do not depart from the scope of the technical idea of the present disclosure are included in the present disclosure.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. A document checking system comprising:
a processor configured to analyze a result of checking a document; and
a memory configured to store a database that holds the analyzed check result, wherein
the processor is configured to:
acquire checked documents that are generated by a plurality of checkers individually checking the document;
extract (i) notes added by the checkers to the checked documents and (ii) marks specifying descriptions related to the notes in the checked documents;
when check information including information on the note and the mark on each extracted checked document satisfies a predetermined condition, determine a check result and register the determined check result in the database; and
when the check information does not satisfy the condition, notify an administrator of the check result, determine the check result based on a determination result made by the administrator and register the determined check result in the database.

2. A grading system comprising:
a processor configured to analyze a result of grading an answer sheet; and
a memory configured to store a database that holds the analyzed grading result, wherein
the processor is configured to:
acquire graded answer sheets that are generated by a plurality of grader individually grading the same answer sheet to a descriptive question;
extract (i) scores described on the graded answer sheets and (ii) marks specifying descriptions on which the scores are based;
when grading information including information on the score and the mark of each extracted graded answer sheet satisfies a predetermined condition, determine a grading result and register the determined grading result in the database; and
when the grading information does not satisfy the condition, notify a grading manager of the grading result, determine the grading result based on a result of a determination result made by the grading manager and register the determined grading result in the database.

3. The grading system according to claim 2, wherein when a difference between the highest score and the lowest score is larger than a threshold value among the scores which are based on the same description on the acquired graded answer sheets, the processor notifies the grading manager of the grading result.

4. The grading system according to claim 3, wherein when the difference between the highest score and the lowest score is smaller than the threshold value among the scores which are based on the same description on the acquired graded answer sheets, the processor unifies the scores of the graded answer sheets into a unified score in accordance with a predetermined rule and registers the unified score in the database.

5. The grading system according to claim 4, wherein the processor unifies the scores which are based on the same description, into an average value of the scores which are based on the same description in all graded answer sheets.

6. The grading system according to claim 2, wherein when descriptions on which the scores are based are different in the acquired graded answer sheets, the processor notifies the grading manager of the graded result.

7. The grading system according to claim 6, wherein when the descriptions on which the scores are based are the same in the acquired graded answer sheets but evaluations of the descriptions are different, the processor notifies the grading manager of the grading result.

8. The grading system according to claim 2, wherein when positions of the descriptions on which the scores are based are different in the acquired graded answer sheets, the processor notifies the grading manager of the grading result.

9. The grading system according to claim 8, wherein when the positions of the descriptions on which the scores are based are the same but evaluations of the descriptions are different in the acquired graded answer sheet, the processor notifies the grading manager of the grading result.

10. The grading system according to claim 2, further comprising:
an input unit configured to allow the graders to input results of grading the answer sheet in a form of electronic data, wherein
the processor acquires the graded answer sheets including the electronic data of the grading results input by the input unit.

11. The grading system according to claim 10, wherein
the input unit comprises
a display configured to display the answer sheet, and
a receiver configured to receive a grader's operation of specifying a display range of the answer sheet displayed on the display, a grader's operation of inputting an evaluation for the specified display range, and a grader's operation of inputting an evaluation for the entire answer sheet.

12. The grading system according to claim 10, wherein
the input unit comprises a reading device configured to optically read the graded answer sheets, and
the processor detects, from images of the graded answer sheet read by the reading device, the scores described on the graded answer sheets and the mark that specify the descriptions on which the scores are based.

13. The grading system according to claim 12, wherein
the processor is configured to
recognize (i) the scores described on the images of the graded answer sheets and (ii) the descriptions specified by the marks, by character recognition, and
determine whether the grading information satisfies the condition based on a result of the character recognition.

14. A grading system comprising:
means for analyzing a result of grading an answer sheet; and
a memory configured to store a database that holds the analyzed grading result, wherein
the means for
acquiring graded answer sheets that are generated by a plurality of grader individually grading the same answer sheet to a descriptive question;
extracting (i) scores described on the graded answer sheets and (ii) marks specifying descriptions on which the scores are based;
when grading information including information on the score and the mark of each extracted graded answer sheet satisfies a predetermined condition, determining a grading result and registering the determined grading result in the database; and
when the grading information does not satisfy the condition, notify a grading manager of the grading result, determining the grading result based on a result of a determination result made by the grading manager and registering the determined grading result in the database.
